(19) United States
(12) Patent Application Publication
(10) Pub. No.: US 2008/0154754 A1
(43) Pub. Date: Jun. 26, 2008

(54) Methods, devices and systems for sharing and selectively overriding tax configurations

(75) Inventors: Isaac J. WILLIAM, Santa Clara, CA (US); Sri Kalyani Sakamuri, Foster City, CA (US); Paulo Valfredo Back, Redwood Shores, CA (US)

Correspondence Address: YOUNG LAW FIRM, P.C., 4370 ALPINE RD., STE. 106, PORTOLA VALLEY, CA, 94028, US

(73) Assignee: Oracle International Corporation, Redwood Shores, CA (US)

(21) Appl. No.: 12/024,060

(22) Filed: Jan. 31, 2008

Related U.S. Application Data
(63) Continuation-in-part of application No. 10/617,327, filed on Jul. 9, 2003.
Application No. 10/617,327 is a continuation-in-part of application No. 10/617,349, filed on Jul. 9, 2003.
Application No. 10/617,349 is a continuation-in-part of application No. 10/106,729, filed on Mar. 26, 2002.
(60) Provisional application No. 60/398,767, filed on Jul. 26, 2002.
(60) Provisional application No. 60/398,769, filed on Jul. 26, 2002.

(51) Int. Cl. G06Q 10/00; G06F 17/10

(52) U.S. Cl. 705/31

(57) ABSTRACT

A computer-implemented method of processing taxes in an enterprise that includes a plurality of legal entities may include a step of maintaining tax content by a first legal entity of the plurality of legal entities. A second legal entity of the plurality of legal entities may then subscribe to all or a portion of the tax content maintained by the first legal entity. Upon occurrence of a taxable event for which the second legal entity incurs a tax liability, the tax content to which the second legal entity has subscribed may be accessed by the second legal entity and the accessed tax content may then be applied by the second legal entity to the taxable event to determine the tax liability incurred by the second legal entity as a result of the taxable event. In this manner, global and local tax content may be selectively shared and selectively overridden across legal entities of an enterprise, such as a multinational corporation.

### CROSS-REFERENCE TO RELATED APPLICATIONS

This application is a continuation-in-part of application Ser. No. 10/617,327, filed Jul. 9, 2003, which claims the benefit of Provisional Application No. 60/398,767, filed Jul. 26, 2002, and a continuation-in-part of application Ser. No. 10/617,349, filed Jul. 9, 2003, which claims the benefit of Provisional Application No. 60/398,769, filed Jul. 26, 2002, and a continuation-in-part of application Ser. No. 10/106,729, filed Mar. 26, 2002, all applications of which are hereby incorporated herein by reference in their entireties and from which priority is hereby claimed under 35 U.S.C. §119 and §1.20. This application is related in subject matter to another continuation-in-part application filed on even date herewith entitled, “Methods, devices and systems for taxable basis implementation.”

### BACKGROUND OF THE INVENTION

The present inventions relate to computer-based systems for calculating and administering taxes. More specifically, the present invention relates to methods, devices and systems for sharing and selectively overriding global tax configurations through a subscription model.

The global marketplace creates tremendous opportunities for businesses to gain new customers, reach global markets and grow revenues, while achieving significant business efficiencies. But with borderless transactions, the need to comply with local tax regulations in this global environment also bring about many and complex challenges. Each new location of operation brought online by a multinational brings new regulations and compliance requirements and may require specific tax configuration strategies if the multinational is using a computer-based system for calculating and administering taxes.

Tax requirements around the world are complex and numerous. With cross-border trade and global operations becoming more common, companies need to address tax compliance issues beyond the borders of the country in which they reside. Global corporations operate without geographical boundaries. However, such global corporations must also comply with local tax regulations that are both varied and complex. Therefore, corporations can no longer rely upon a detailed understanding of the taxes of their country of origin. On the other hand, it would be tedious and wholly impractical for a legal and business entity such as a global corporation located in one country to fully comprehend the tax requirements of every other country in which they do business. Therefore, it is important for tax information to be accessible across national and legal boundaries and shared, both to avoid redundancy and to ensure consistency.

### SUMMARY OF THE INVENTION

According to an embodiment thereof, the present invention is a computer-implemented method of processing taxes in an enterprise that includes a plurality of legal entities. The method may include steps of maintaining tax content by a first legal entity of the plurality of legal entities; subscribing, by a second legal entity of the plurality of legal entities, to at least a portion of the tax content maintained by the first legal entity; upon occurrence of a taxable event for which the second legal entity incurs a tax liability, accessing at least a portion of the tax content to which the second legal entity has subscribed, and applying the accessed tax content to the taxable event to determine the tax liability incurred as a result of the taxable event.

The maintaining step may be carried out with the first legal entity being a Global Content Owner (GCO) and the tax content maintained by the GCO may be visible to each of the plurality of legal entities of the enterprise. The maintaining step may be carried out with the first legal entity further carrying out a step of subscribing to tax content maintained by a third legal entity of the plurality of legal entities of the enterprise. The tax content may include tax content of a plurality of tax regimes and the subscribing step may include the second legal entity selecting to which of the plurality of tax regimes it is subscribing. The maintaining step may be carried out with the tax content including tax rates, tax rules, formulae and tax statuses, for example. The maintaining step may include a step of receiving the tax content from, e.g., a tax service provider. The second legal entity may maintain tax content and the method may further include determining whether to apply the tax content maintained by the second legal entity or whether to access and apply the content maintained by the first legal entity to which the second legal entity has subscribed.

The second legal entity may maintain tax content and the subscribing step may further include a step of specifying a content subscription option, the content subscription option indicating that the accessing and applying steps are to be carried out only when the tax content maintained by the first legal entity is not active or does not apply to the taxable event. When the tax content maintained by the first legal entity applies to the taxable event, the method may further include the step of the second legal entity accessing the tax content maintained by the second legal entity and applying the accessed tax content to the taxable event to determine the liability incurred as a result of the taxable event. The tax content may include tax content of a plurality of tax regimes and each of the tax regimes may further include a date from which the tax regime is effective. Each of the tax regimes may further include an end date after which the tax regime is no longer effective. The subscribing step may be effective only outside of a time period during which the subscription of the first legal entity to the tax content maintained by the third legal entity is active. The first legal entity may maintain a flag configured to assume a first or a second state, the first and second states allowing and disallowing subscriptions, respectively, by other legal entities, to the tax content maintained by the first legal entity. The subscribing step may be effective only for a tax regime and/or for a time period selected by the second legal entity.

According to another embodiment thereof, the present invention is a computer system for processing taxes in an enterprise that includes a plurality of legal entities, a first legal entity of the plurality of legal entities maintaining tax content. The computer system may include at least one processor; at least one data storage device coupled to the at least one processor and a plurality of processes spawned by the at least one processor. The processes may include processing logic for subscribing, by a second legal entity of the plurality of legal entities, to at least a portion of the tax content maintained by the first legal entity; upon occurrence of a taxable event for which the second legal entity incurs a tax liability, accessing at least a portion of the tax content to which the second legal entity has subscribed, and applying the accessed tax content to the taxable event to determine the tax liability incurred as a result of the taxable event.

Another embodiment of the present invention is a machine-readable medium having data stored thereon representing sequences of instructions which, when executed by a computing device, causes the computing device to process taxes in an enterprise that includes a plurality of legal entities, a first legal entity of the plurality of legal entities maintaining tax content, by performing the steps of: subscribing, by a second legal entity of the plurality of legal entities, to at least a portion of the tax content maintained by the first legal entity; upon occurrence of a taxable event for which the second legal entity incurs a tax liability, accessing the at least portion of the tax content to which the second legal entity has subscribed, and applying the accessed tax content to the taxable event to determine the tax liability incurred as a result of the taxable event.

According to still another embodiment thereof, the present invention is a computer-implemented method of processing taxes in an enterprise that includes a plurality of legal entities, comprising the steps of: storing tax content locally to at least some of the plurality of legal entities; subscribing, by a legal entity that stores tax content locally, to the tax content that is stored locally to a selected other one of the plurality of legal entities; causing the subscribing legal entity to selectively access, upon occurrence of a taxable event, either the tax content to which it has subscribed or the tax content that is stored locally to the last one of the plurality of legal entities, and causing the subscribing legal entity to apply the selectively accessed tax content to the taxable event to determine the tax liability incurred as a result of the taxable event.

The subscribing step may be effective for a selected tax regime and/or for a selected time period. The storing step may be carried out with the locally stored tax content being effective for a selected tax regime and/or for a selected time period. The selective access step may be carried out without the subscribing legal entity having knowledge of the legal entity from which the tax content to which it has subscribed is fetched.

### BRIEF DESCRIPTION OF THE DRAWINGS

FIG. 1 illustrates a distributed computer system in accordance with an embodiment of the present invention.

FIG. 2 illustrates the structure of a tax service in accordance with an embodiment of the present invention.

FIG. 3 shows tables illustrating the manner in which a legal entity such as a corporation may subscribe the tax content owned by another legal entity.

FIG. 4 shows an example of a tax content subscription hierarchy, according to an embodiment of the present invention.

FIG. 5 is a block diagram illustrating aspects of tax content subscription options according to embodiments of the present invention.

FIG. 6 is another block diagram illustrating aspects of tax content subscription options according to embodiments of the present invention.

FIG. 7 is a block diagram illustrating further aspects of tax content subscription options according to embodiments of the present invention.

FIG. 8 is a block diagram illustrating further aspects of tax content subscription options according to embodiments of the present invention.

FIG. 9 is a block diagram of a computer with which embodiments of the present invention may be practiced.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

### Definitions

Tax Jurisdiction: a zone in which a tax type is levied by a specific tax authority. e.g.: the tax jurisdiction for income tax in the United States is the country of the United States; the tax jurisdiction for a San Jose City Tax is the City of San Jose.

Tax Content: A set of data including rates, rules, regulations and formulae that are needed for tax calculation, reporting or settlement. [a.k.a. Tax Configuration]

Tax Content Provider: a supplier that provides any tax content information. e.g.: a tax administrator, a third party tax content supplier of rates, and rate exceptions, rules, and exemption regulations, etc.

Taxable Event: a transaction that requires one or more taxes to be charged.

Tax Regime: the set of tax rules that determines the treatment of one or more taxes that have been grouped by a tax authority for administrative other purpose. For example, the Excise Tax Regime in India includes rules for Excise Tax, Additional Excise Tax; VAT Regime in Argentina includes rules for Standard VAT, Additional VAT, and Perception VAT.

Tax Service: defines the interaction points or interfaces between the tax world and the business world and provides information to the business world for the purpose of meeting tax compliance and management needs.

Tax Subscriber: a party that subscribes to a published (tax) service.

First Party Organization (FPO): A First Party Organization is either a legal entity or an operating unit that belongs to the enterprise that is running an application that implements an embodiment of the present invention. When tax content, such as the tax, the jurisdiction and rates, the rules, etc. for a given regime, is created, it is created by or on behalf of a First Party Organization. When the tax content (or tax configuration) is created by or on behalf of the First Party Organization for a tax regime, then the FPO is the tax content owner (or tax configuration owner for the regime).

Content Owner: A content owner is a First Party Organization that owns the responsibility of defining and maintaining the tax content for a given tax regime. When a content record, such as a tax rate for a tax in a given regime is created, it is created by (or on behalf of) a First Party Organization. This First Party Organization is said to be the “content owner” for that content record. The term scope of the phrase “content owner” may be extended to refer to a First Party Organization that chooses to own content for one or more tax regimes.

Global Content Owner (GCO): A special content owner that can own data visible to the entire enterprise that is running an application that implements an embodiment of the present invention, and that need not directly does not correspond to any “real” First Party Organization. A global content owner, thus, may be an abstract or pseudo “global” entity that can create content that can be shared with and used by all legal entities within the enterprise. The GCO, therefore, provides a mechanism by which the tax department of a company can maintain tax content centrally. Any legal entity can then subscribe to content defined by Global Content Owner for all or specific regimes by means of content subscription.

Legal Entity: A party that has the right to transact business within a tax jurisdiction, and is subject to taxes when carrying out a taxable event. For example, a multi-national enterprise may include a plurality of legal entities, dispersed widely across geo-political boundaries.

Regime Usage: Regime usage indicates that a given tax regime is of interest to a First Party Organization. Regime usage may be delimited by Effective From and Effective To dates. A First Party Organization may specify usage for regimes, for which it would be liable to pay, collect and/or report taxes.

Content Subscription Option: Content subscription option is the choice made as to the source of tax content for a regime usage and may modify the terms of a subscription to tax content. This choice determines whose content is to be used by a legal entity to process taxes for a given regime.

Content Subscription: Content subscription is the means by which a legal entity such as a First Party Organization (FPO) can specify a content subscription option to indicate whether it intends to use the tax content of another FPO/Content Owner/Global Content Owner/Parent Content Owner for processing taxes of its transactions for a given regime usage.

Open Subscription Model: One or more legal/business entities will own tax content in this model. Other legal/business entities may access and use such content through a tax content subscription. While transaction data should be secured using the data security mechanism of the application product using tax services, the subscription of tax content should be obtainable through a subscription hierarchy, which may not necessarily coincide with the legal entity/reporting hierarchy.

### Overview of Taxes and Jurisdictions

To understand what a jurisdiction is, a brief description and a few examples of jurisdictions are provided. Each country can have one or more systems of taxation, each of which deals with the taxation of specific aspects of a business transaction. For example, a “Sales” type of taxation system deals with the rules and regulations of how a sales transaction should be taxed. Similarly, a “Value Added Tax” (or, “VAT”) type of taxation system deals with how the value addition in a manufacturing and/or sales lifecycle needs to be taxed. This system of rules and regulations is called a tax regime. A tax regime is implemented through one or more distinct charges. Each such specific charge is called a tax. Therefore, a regime may include one or more different taxes. The imposition of a tax is limited typically by a geographical and/or political boundary, in most cases around a contiguous political/administrative area, such as a city or a county. However, in some cases, a tax may be imposed, or may vary owing to belonging to a non-political demarcation, such as a free-trade zone. The incidence of a tax on a geographical area is called a tax jurisdiction.

A jurisdiction may be created for a country, a state within a country, a county within a state, or a city within a county. In certain cases, a jurisdiction may need to encompass, for example, a couple of cities; or, a county and an adjoining city belonging to a neighboring county. Or, as explained above, jurisdictions may be created for areas such as free-trade zones, export processing zones, etc. Jurisdictions may be created that encompass multiple countries that have banded together to form an economic union.

TABLE 1

| Country | Tax Regime | Tax | Tax Type | Tax Jurisdiction |
|---|---|---|---|---|
| United States | Sales Tax | State Sales Tax | Sales Tax | State |
| | Sales Tax | District Tax | Sales Tax | City |
| Canada | Goods and Services Tax | GST | VAT | Country |
| | Goods and Services Tax | HST | VAT | Province |
| | Sales Tax | PST | Sales Tax | Province |
| Singapore | Goods and Services Tax | GST | VAT | Country |
| India | Excise and Customs | Excise Tax | VAT | Country |
| | Excise and Customs | Additional Excise Tax | VAT | Country |
| | Excise and Customs | Customs Duty | Customs | Country |
| Brazil | RICMS - ICMS Rules | ICMS | VAT | State |
| | RICMS - ICMS Rules | ICMS-ST | VAT | State |
| | RIPI - IPI Rules | IPI | VAT | Country |
| | RII - II Rules | II | Customs | Country |
| Portugal | VAT | Domestic VAT | VAT | Country |
| Portugal | VAT | Inter-EU VAT | VAT | Country |

Table 1 illustrates different exemplary tax regimes, tax jurisdictions, and taxes for different countries. Table 1, reading from left to right, goes from the highest level to the most detailed level of granularity. There may be one or more tax regimes in a country; each regime can consist of one or more taxes; each tax is of a given tax type, which is a high level classification such as Sales Tax, Excise Tax and Mineral Oil Tax; and each tax can be levied in one or more tax jurisdictions (for one or more geographical elements).

### Distributed Computer System

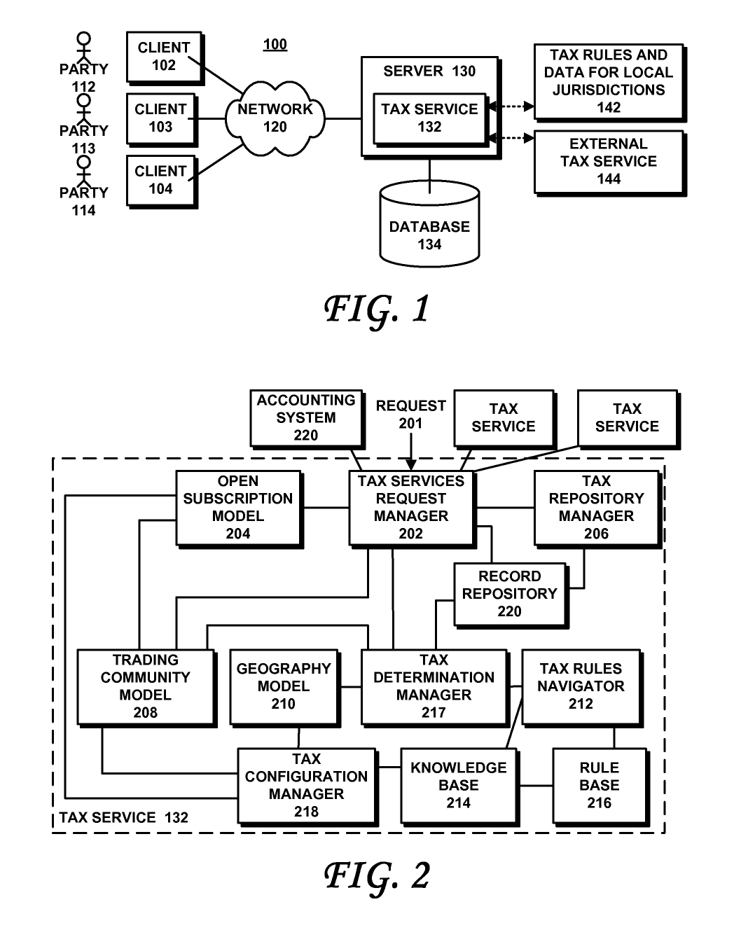

FIG. 1 illustrates distributed computer system 100 in accordance with an embodiment of the present invention. Distributed computer system 100 includes a number of clients 102-104 coupled to a server 130 through a network 120. Clients 102-104 can generally include any device on a network including computational capability and including a mechanism for communicating across the network. Clients 102-104 operate under control of parties 112-114, respectively. (Note that the term “parties” here refers to users of the computer system; it is not the same as the parties involved in taxable transactions.)

Server 130 can generally include one or more (interconnected) computing devices, including a mechanism for servicing requests from clients 102-104 for computational and/or data storage resources. Note that clients 102-104 and server 130 can generally include any type of computing device, including, but not limited to, a computer system based on a microprocessor, a mainframe computer, a digital signal processor, a portable computing device, a personal organizer, a device controller, and a computational engine within an appliance.

Network 120 can generally include any type of wire or wireless communication channel capable of coupling together computing nodes. This includes, but is not limited to, a local area network, a wide area network, or a combination of networks. In one embodiment of the present invention, network 120 includes the Internet.

Server 130 is coupled to a database 134, which contains data that is used by applications running on server 130. Note that these server-based applications may be running on behalf of remote applications on clients 102-104. Database 134 can generally include any type of system for storing data in non-volatile storage. This includes, but is not limited to, systems based upon magnetic, optical, and magneto-optical storage devices, as well as storage devices based on flash memory and/or battery-backed up memory.

Server 130 acts as a host machine for tax service 132. This allows applications running on clients 102-104 to make requests across network 120 to tax service 132 running on server 130. For example, an application running on client 102 can send a request to tax service 132 to perform the tax calculation, including determination of the local jurisdictions involved and, further, performing the computations necessary for each of the local jurisdictions.

Note that tax service 132 is configured so that it can optionally receive tax rules and data for local jurisdictions 142 from an external source, such as a tax expert for the local jurisdiction, prior to a request such as made by clients 102-104. Further, tax service 132 is configured to use tax rules and data received from an external source in servicing a request from a client. Furthermore, tax rules and data 142 can be encoded in a published format, such as extensible markup language (XML) or electronic data interchange (EDI) format, to facilitate receiving the tax rules and data 142 from different sources. Note that tax rules and data 142 can be communicated to tax service 132 across network 120.

Tax service 132 is additionally configured so that it can operate with an external tax service 144 provided by an external tax service provider. In this way, the external tax service provider can service the request with an operation (internal to tax service 144), such as a database lookup of a tax rate or a tax computation, in order to facilitate completing a tax operation for a specific jurisdiction by tax service 132. Furthermore, note that this external tax service provider may be located on a remote server that is accessible through network 120. A given request can be partially fulfilled by tax service 132 using tax rules and data 142 for one or more local jurisdictions, while using the tax service 144 of an external tax service provider to perform the computations for another local jurisdiction that might be simultaneously applicable.

### Tax Service Structure

FIG. 2 illustrates the structure of tax service 132 in accordance with an embodiment of the present invention. Tax service 132 includes a number of modules, including Tax Services Request Manager (TSRM) 202, open subscription module 204, tax repository manager 206, Trading Community Architecture (TCA) model 208, geography model 210, tax determination manager 217, tax rules navigator 212, tax configuration manager knowledge base 214, and rule base 216.

TSRM 202 generally manages interactions between external business transactions and tax processing operations. In one embodiment of the present invention, TSRM 202 is implemented as a set of published services that an external business application running on clients 102-104 may request. As is illustrated in FIG. 2, TSRM 202 receives a request 201 to perform a tax processing operation from an application running on one of clients 102-104.

Open subscription model 204 defines the security and access protocols used by TSRM 202 as well as tax rules navigator 212, tax determination manager (TDM) 217, tax configuration manager (TCM) 218 and tax administration manager 222. It also allows subscribers, such as parties 112-114, to select, request and receive tax services other legal entities, other tax content owners and/or from either tax service 132 and/or various external service providers, such as tax service 144. During operation, open subscription module 204 may, according to some implementations, communicate with trading community model 208, which represents various parties, sites and locations involved in the tax operations in a standardized format.

Tax repository manager 206 provides services that facilitate the storage into and retrieval of data from the record repository 220. These services may be used by the tax determination manager 217 and tax administration manager 222. According to embodiments of the present invention, the server 130 that carries out the processing to determine the taxes need not be aware of which legal entity/GCO/etc. that the tax content is fetched from. Indeed, in the course of processing for taxes, the tax engine (such as the tax determination manager 217) will read from the knowledge base which may, according to embodiments of the present invention, form part of the tax content repository. For example, the tax determination manager 217 may read a tax rate table, using standard SQL. In so doing, however, the tax determination manager (or other mechanism that reads from the knowledge base 214) need not be aware how the records are selected. Indeed, selecting the records for the requested read may be carried out by creating one or more views and synonyms, (for example), so that the tax determination manager 217 may be coded as if it was simply reading from a table, whereas the knowledge base 214, according to embodiments of the present invention may not be a simple table, but a database view in addition to other features that provide a rate table that, transparent to a reading process such as 217, provides only those records that are applicable.

Geography model 210 contain information about the geographical boundaries of the various jurisdictions associated with different tax regimes.

Tax configuration manager 218 provides services that can provide information from and/or can write information into, the geography model, the Trading Community Model, an inventory system, tax services request manager 202, tax determination manager 217, tax rules navigator 212 and tax administration manager 222.

Tax rules navigator 212 facilitates access to tax data contained in knowledge base 214 and tax rules contained in rule base 216. Note that knowledge base 214 and tax rules 216 may actually reside within database 134 illustrated in FIG. 1.

### Subscription Model

The following details a tax content subscription model that may be implemented according to embodiments of the present invention (for example, in the open subscription model 204 of FIG. 2, although embodiments of the present invention are not limited thereby). A legal/business entity may want to own—i.e., to define, maintain, assume and/or retain the responsibility to create and manage—tax content in this model. Other legal/business entities may want to use such content by subscribing to the tax content that is “owned” by that legal entity. A subscription to tax content, therefore, enables the sharing of tax content across legal and/or business entities. While transaction data should be secured using the data security mechanism of the application product that requests the tax service, the tax content that is used in servicing that request is, according to embodiments of the present invention, obtainable through a subscription. The present content subscription model may be extended to cover situations in which a legal entity subscribes to the content of another legal entity, which in turn itself subscribes to the content of a third legal entity, thereby establishing a two or higher level subscription hierarchy. This subscription hierarchy need not necessarily coincide with the legal entity reporting hierarchy nor need the subscription hierarchy necessarily correspond with the manner in which the transaction data itself is secured or with the manner in which the enterprise itself is organized, either from a legal or business point of view.

Embodiments of the present invention provide a legal entity with the ability to selectively use (e.g., subscribe to) all or some (i.e., less than all)—or none—of the tax content of another legal entity. Moreover, the (subscribing) legal entity may want to fine-tune (e.g., override) some of that content owing to local requirements or unique circumstances (such as local tax incentives and the like). In addition, embodiments of the present invention may include a mechanism may be provided to allow sharing of tax content across the enterprise so that a change made by a central agency (for example, a Global VAT department) will be reflected for all (subscribing) legal/business entities. Also, embodiments of the present invention provide a mechanism by which a legal entity can change its subscription from one legal entity to another or to have the capability to manage its own tax content.

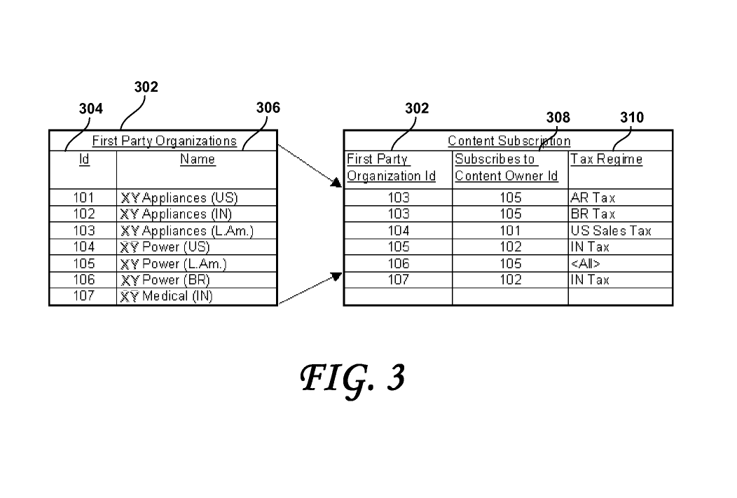

According to embodiments of the present invention, and as shown in FIG. 3, embodiments of the present invention may define First Party Organizations 302 (legal entities for or by which tax content, such as a tax for a given regime, is created) by, for example, ID as shown at 304 and Name, as shown at 306. As shown in FIG. 3, the FPO XY Appliances (Latin America) has an ID of 103. FPOs, as shown in the right hand table of FIG. 3, may subscribe to the tax content (including, for example, tax status, tax rates, tax rules, formulae) of another legal entity. Specifically, FPOs may subscribe to the tax regime of one or more other FPOs. For example and with reference to the exemplary case illustrated in FIG. 3, the FPO XY Appliances (Latin America) (ID 103) subscribes to the configuration of an Argentinian tax regime (AR Tax) defined by ID 105, XY Power (Latin America), as shown by the columns 308 and 3 10. That is, the FPO having ID 103, through the subscription, indicates that it intends to use the tax content of FPO/Content Owner 105 for processing taxes for transactions that come under the purview of the Argentina (AR) Tax Regime. In this example, therefore, XY Power (Latin America) is the legal entity that “owns” the responsibility of defining (or obtaining) and maintaining the tax content for a given tax regime, in this case the AR Tax Regime. ID 103, as shown in FIG. 3, also subscribes to the tax content of FPO ID 105 for a Brazilian Tax Regime (BR tax). Therefore, a FPO may subscribe to more than one content owner, for different tax regimes. Also, a FPO may subscribe to a FPO/content owner for all tax regimes, as shown in FIG. 3, in which FPO 106 (XY Power (Brazil)) subscribes to all tax content (i.e., for all tax regimes) of FPO/Content Owner 105. As is shown below, embodiments of the present invention allow for sharing tax content through subscriptions. Various subscription options, discussed hereunder, enable a fine grained control and great flexibility over the manner in which one FPO may subscribe to the tax content of another FPO/legal entity/content owner.

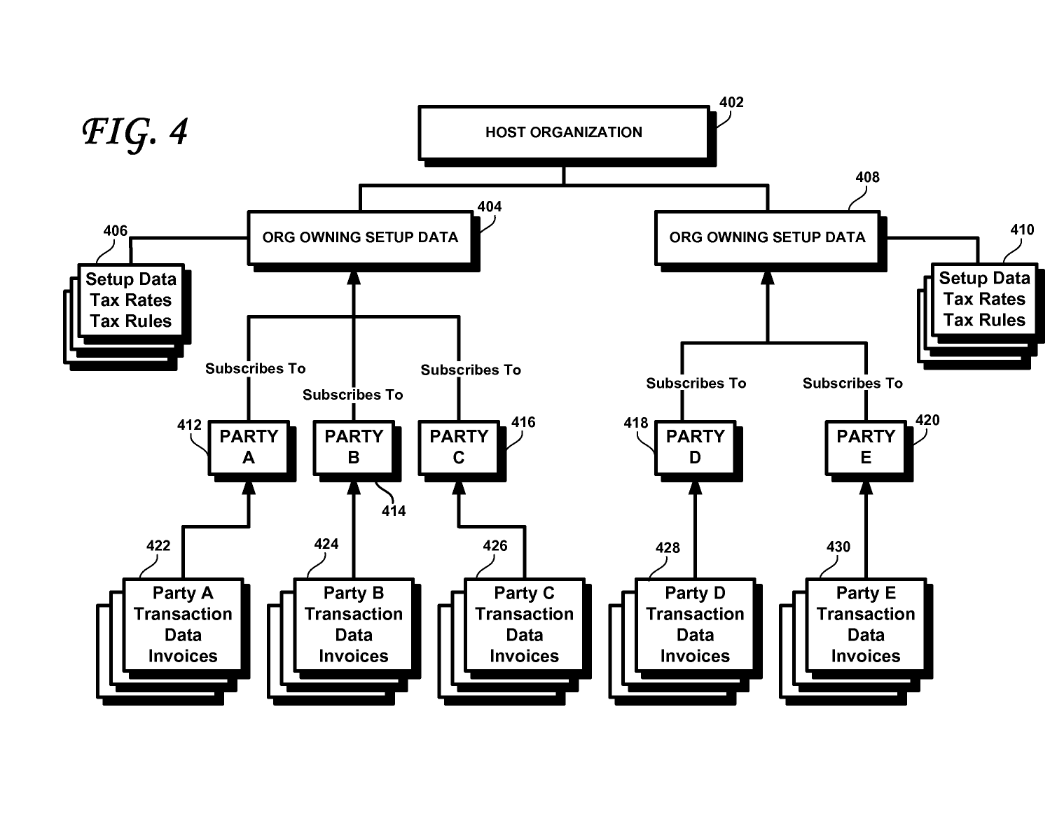

FIG. 4 shows an example of a tax content subscription hierarchy, according to an embodiment of the present invention. A Host Organization 402 may (but need not) be configured as a Global Content Owner (GCO), a special content owner that represents the enterprise and can own data visible to the entire enterprise (i.e., across the constituent legal entities of the enterprise) that is running an application that implements an embodiment of the present invention, and that need not directly does not correspond to any “real” First Party Organization. A global content owner, thus, may be an abstract “global” entity that can create content than can be used by all legal entities within the enterprise, such as the organizations 404, 408. Alternatively, the Host Organization may simply be a legal entity to which the organizations 404, 408 report. The Global Content Owner 402 may “own”, have access to or be otherwise coupled to tax content for a plurality of tax regimes. In FIG. 4, the Global Content Owner 402 is shown coupled to tax content (including, without limitation, tax rates and tax rules) for, e.g., Argentina (AR) as shown at 401 and Brazil, as shown at 403. The organizations 404, 408 may be FPOs, and may “own” respective tax content 406, 410 that may include, for example, tax setup date, tax status tax rates and tax rules. In turn, parties 414, 412 and 416 may subscribe to the tax content of organization 404 and parties 418 and 420 may subscribe to the tax content of organization 408, each for all or selected tax regimes. In this manner, the transaction data and invoices 422 of FPO party A 412 will be processed according to the tax content (rates, rules, etc.) and for the tax regime(s) to which party A has subscribed; namely the tax content 406 of FPO organization 404. The transaction data and invoices 424 of Party B 414 and the transaction data and invoices 426 of Party C 416 will be processed in the same manner; namely, according to their respective subscriptions to the tax content 406 owned by Organization 404. Similarly, the transaction data and invoices 428 of Party D 418 and the transaction data and invoices 430 of Party E 420 will be processed according to their respective subscriptions to the tax content 410 owned by FPO Organization 406, as shown in FIG. 4.

To satisfy the tax compliance requirements of a certain locale, a tax content provider may be used to provide all or part of the setup data, tax rates, and rules 406, 410. Indeed, a tax content provider may be used either to obtain the data only (such as tax rates, rules and exceptions) or to make use of more comprehensive services including tax determination and reporting. A tax content provider may be defined as a person or entity that interprets rules and regulations specified by a Tax Authority and transforms and provides the rules and regulations in a structured way that another computer system/program that performs the task of determining taxes, etc. may be able to utilize. Or, alternatively, the tax content provider may provide the system/programs, etc., that perform the task of determining taxes, etc., using the tax content. A very small (and arguably straightforward, despite appearances) excerpt from one such set of regulations of one Tax Regime (Revenue and Taxation code Section 6201-6207, California Revenue And Taxation Code) reads:
6051. For the privilege of selling tangible personal property at retail a tax is hereby imposed upon all retailers at the rate of 2½ percent of the gross receipts of any retailer from the sale of all tangible personal property sold at retail in this state on or after Aug. 1, 1933, and to and including Jun. 30, 1935, and at the rate of 3 percent thereafter, and at the rate of 2½ percent on and after Jul. 1, 1943, and to and including Jun. 30, 1949, and at the rate of 3 percent on and after Jul. 1, 1949, and to and including Jul. 31, 1967, and at the rate of 4 percent on and after Aug. 1, 1967, and to and including Jun. 30, 1972, and at the rate of 3¾ percent on and after Jul. 1, 1972, and to and including Jun. 30, 1973, and at the rate of 4¾ percent on and after Jul. 1, 1973, and to and including Sep. 30, 1973, and at the rate of 3¾ percent on and after Oct. 1, 1973, and to and including Mar. 31, 1974, and at the rate of 4¾ percent thereafter.

This might be interpreted by a tax professional as follows:

| Tax | Tax | Tax | Type of | Type of | Effective | Effective | Tax |
|---|---|---|---|---|---|---|---|
| Regime | Type | Jurisdiction | Company | Goods | From | To | Rate |
| US Sales | Sales | California | Retailer | Tangible | Aug. 1, 1933 | Jun. 20, 1935 | 2.5% |
| Tax | Personal | Property | | | | | |
| US Sales | Sales | California | Retailer | Tangible | | | |
| Tax | Personal | Property | | | | | |
| US Sales | Sales | California | Retailer | Tangible | Apr. 1, 1974 | | 10.75% |
| Tax | Personal | Property | | | | | |

The table above represents the data that may be referred to as tax content. Tax content may, therefore, include more than just the regulations that are published by a Tax Authority. Indeed, tax content may include data that has been processed and interpreted by a professional, with the expertise of interpreting tax regulations; and organized and structured in a manner that is amenable to being understood by someone who is somewhat less than a tax professional. A party that provides such Tax Content, usually for a fee, and who guarantees the accuracy, the timeliness and the validity (e.g., that the tax rates are always current) is a Tax Content Provider. Legal entities, according to embodiments of the present invention, may define and maintain their own tax content or may obtain such tax content from a Tax Content Provider.

Just as there are Tax Content Providers, there are companies who undertake not only to maintain Tax Content but also to process the content and perform actions such as determining the tax amount and tax reporting. The actions or processing performed using the tax content can be termed as Tax Services and companies which specialize in providing Tax Services are called Tax Service Providers. Embodiments of the present inventions may be used in conjunction with or by such Tax Service Providers.

As embodiments of the present inventions operate in a hosted environment, it is not necessary for the parties (such as parties 412, 414, 416, 418 and 420) to use or maintain specialized software in order to subscribe to particular tax content or to process the taxes associated with their taxable events. The same applies to Organizations 404 and 408, if the Host Organization 402 operates as the host to which the organizations and parties connect to subscribe to tax content and use the tax content to which they have subscribed. The hosted environment facilitates the sharing and overriding of tax content across legal entities of an enterprise. However, just as it is important for tax information to be shared to avoid redundancy, ensure consistency and enable transactions to be easily integrated and processed for tax-related purposes, it is also important that tax-related transactional information (such as would be part of 422, 424, etc.) pertaining to one user or entity is not visible by another user or entity that does not have sufficient privileges to do so.

### Content Subscription Options

To define a tax content subscription for a legal entity and a tax regime according to embodiments of the present invention, the following steps may be carried out. At the outset, the “regime usage(s)” for the legal entity, such as the FPO should be defined. First, the user needs to tell the system to which tax regimes a particular legal entity (i.e., FPO) is subject. For example a US legal entity of a company may be subject to the US Sales Tax Regime, whereas an Argentinean legal entity of the same company may be subject to one or more Argentinean regimes, such as the Argentina VAT and Excise Tax Regimes. This is done by defining the regime usage of a legal entity. Then, for each defined regime usage, one or more content subscription options should be defined, as described hereunder. By way of content subscription according to embodiments of the present invention, a legal entity such as a FPO may specify a content subscription option to indicate whether it intends to use its own tax content or the tax content of another (hierarchically higher, for example) legal entity or an entity such as a GCO (for example) for processing taxes of its transactions for a given regime usage. A FPO, according to embodiments of the present invention, specifies one or more regime usages for one or more tax regimes, for which it would be liable to pay, collect and/or report taxes. A content subscription option, therefore, may be defined as the choice made by a legal entity as to the source of tax content for a regime usage. This choice determines whose content is to be used for a FPO to process taxes for a given regime, in response to a taxable event, an event for which the legal entity incurs a tax obligation of some kind. Regime usages may further specify an Effective From date (i.e., a beginning date), an Effective To date (i.e., an end date) and/or a date range for which the FPO is liable to pay, collect and/or report taxes under the specified tax regime, and for which date range a specific content subscription option applies.

TABLE 2
Regime Usage

| | | | | Content |
|---|---|---|---|---|
| FPO | Start | End | Regime | Option |
| 101 | Jan-03 | Jun-03 | R1 | GCO |
| 101 | Jul-03 | Dec-03 | R1 | Own |
| 101 | Jan-04 | | R1 | Own/GCO |
| 101 | Jan-03 | Jun-03 | R2 | Own |
| 101 | Jul-03 | | R2 | GCO |

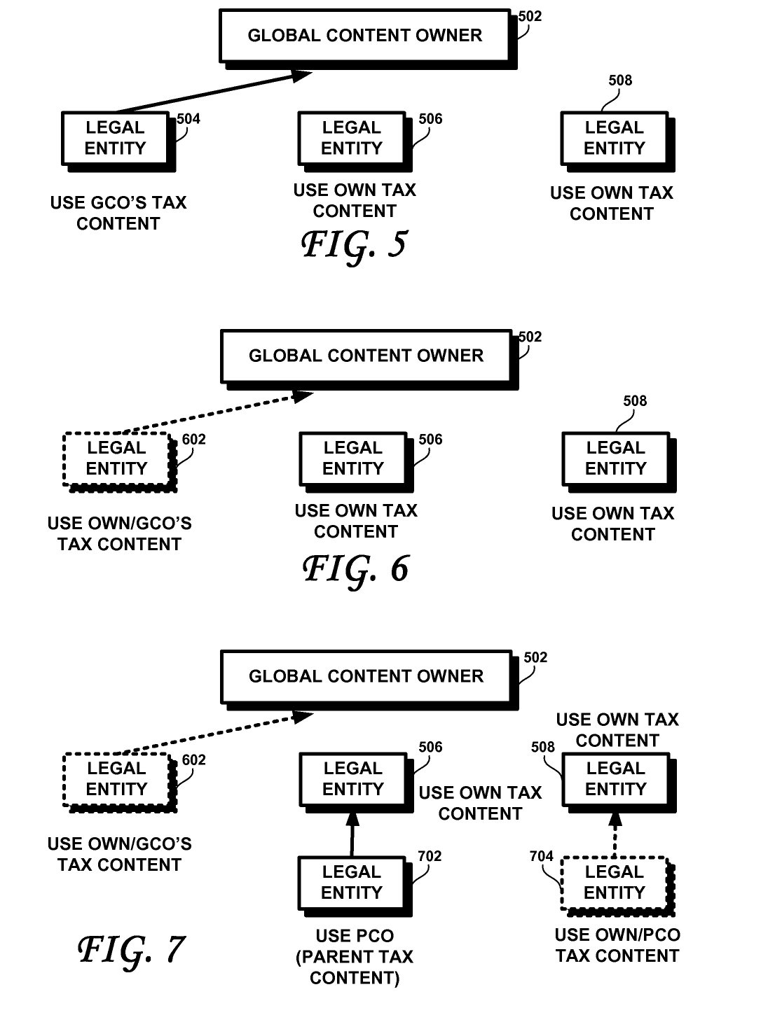

As shown in Table 2 above, the tax regime usage indicates an association of a tax regime with a FPO, and the content subscription options may be chosen with a given tax regime, and may vary over the effective dates specified in the regime usage. For example and with reference to Table 2, the FPO having an ID of 101 has subscribed to tax regime R1, from January 2003 to June 2003, during which time it has specified that “GCO” is its chosen content subscription option. Indicating “GCO” as a content subscription option signals that FPO 101 wishes to use the tax content defined and maintained by the GCO for processing, collecting, paying and/or reporting any taxes associated with taxable events within the indicated date range from January 2003 to June 2003. Again with reference to Table 2, FPO 101 has also selected “Own” as the content subscription option for processing, collecting, paying and/or reporting any taxes associated with taxable events within the indicated date range of July 2003 to December 2003. Indicating “Own” as a content subscription option signals that FPO 101 wishes to use the tax content defined and maintained by the FPO (itself) for processing, collecting, paying and/or reporting any taxes associated with taxable events within the indicated date range. FIG. 5 illustrated the content subscription options “GCO” and “Own”. As shown therein, legal entity 504 has specified “GCO” as content subscription option for at least one tax regime meaning that, for the specified tax regime and tax regime usage, the legal entity 504 will use the tax content defined and maintained by the GCO 502. The legal entities 506 and 508, on the other hand, have each specified “Own” as the content subscription option for a specified tax regime and tax regime usage. That is, they have elected to define and use their own tax content for the specified tax regime and tax regime usage. This does not prevent, however, the legal entities 506 and 508 from subscribing to and using the GCO's tax content for other tax regimes and for other tax regime usages.

Table 2 also indicates that FPO 101 has subscribed to the tax regime R1 for the period beginning January 2004 onward (there being no end date for the regime usage indicated). FPO 101 has also selected “Own/GCO” as the content subscription option for processing, collecting, paying and/or reporting any taxes associated with taxable events occurring during the month of January 2004 onward. Indicating “Own/GCO” as a content subscription option signals that FPO 101 wishes to use the tax content defined and maintained by the FPO (itself) for processing, collecting, paying and/or reporting any taxes associated with taxable events during and after January 2004. The “Own/GCO” content subscription option, according to embodiments of the present invention, also signals that if FPO's own tax content is missing, to use the tax content defined (or otherwise procured or obtained) and maintained by the GCO for processing, collecting, paying and/or reporting any taxes associated with taxable events during and after January 2004. FIG. 6 is a block diagram illustrating the “Own/GCO” content subscription option. Therein, legal entity 602 has selected the “Own/GCO” content subscription option for a specified tax regime and tax regime usage meaning that it has selected to define and maintain its own tax content for partially for one or more of the taxes of the tax regime to which the legal entity 602 is potentially subject. In the absence of its own tax content to process one or more applicable taxes of the regime (defined by the regime usage), legal entity 602 will use the tax content of the GCO 502.

Each of the tax regime usages may be associated with a tax regime usage ID and the content subscription options (“Own”, “GCO” and “Own/GCO”) may each be associated with a unique content subscription option ID.

The “Own/GCO” content subscription option allows a legal entity to override the GCO's tax content for a specified tax regime for some or all taxes of the regime and to use the GCO tax content otherwise. Indeed, according to embodiments of the present invention, any legal entity may override the tax content of a GCO, provided that the legal entity has the ability to define or otherwise obtain and maintain its own tax content for the tax regime(s) and for the period(s) in which the legal entity desires to override the GCO's tax content. For example, a FPO legal entity may have been granted special advantageous tax rates for city and county sales taxes in exchange for locating a facility within the city's and county's boundaries. In that case, the FPO could define and maintain its own tax rates for those specific tax jurisdictions, but use its GCO's tax content for all other taxes (i.e., state, federal, etc.) and jurisdictions, thereby using its own tax content when appropriate and sharing tax content when warranted. The “Own/GCO” content subscription option, therefore, enables an FPO to share the tax content defined and maintained by the GCO while having the flexibility to override any GCO-defined tax content where such content is defined and maintained by the FPO itself.

Table 3 shows an example of tax content that comes into play when the “Own/GCO” content subscription option is used, enabling the sharing and override capabilities of embodiments of the present invention.

TABLE 3

| TAX | | TAX | | | TAX | | | | |
|---|---|---|---|---|---|---|---|---|---|
| RATE | CONTENT | REGIME | | TAX STATUS | JURIS | TAX RATE | | EFFECTIVE | EFFECTIVE |
| ID | OWNER ID | CODE | TAX | CODE | CODE | CODE | % RATE | FROM | TO |
| 10 | −99 | US_SALES_TX | STATE | STANDARD | CA | STNDRD_RT | 6.25 | 1-Jan-04 | NULL |
| 56 | 101 | US_SALES_TX | STATE | STANDARD | CA | STNDRD_RT | 6 | 6-Jul-04 | 31-Dec-05 |
| 241 | 101 | US_SALES_TX | STATE | STANDARD | CA | STNDRD_RT | 5.75 | 8-Aug-06 | NULL |

As shown, Table 3 details the tax rates for the jurisdiction of California (Tax Jurisdiction Code CA) for the STANDARD tax status of the STATE tax of the US_SALES_TX tax regime) for a number of dates ranges. Each of the tax rates (5.75%, 6% and 6.25%) is identified with a tax rate ID (10, 56 and 241, respectively). The tax content owner for each of these rate and tax regime usage date ranges is identified by the Content Owner ID column, where 101 is the content owner ID of the FPO, and wherein −99 is the content owner ID reserved for the GCO in this example. Therefore, and with reference to Table 3, the legal entity (equivalent to content owner ID of 101 in Table 3 and elsewhere in this paragraph) having the responsibility to process, collect, pay and/or report STATE tax (in this example) of the US_SALES_TX tax regime, uses the tax rate record defined by the GCO (content owner ID −99) for taxable events that occur from January 2004 onward (effective to date set to NULL, indicating no ending date), with a tax of 6.25% (corresponding to ID of 10 in Table 3.) From Jul. 6, 2004 to Dec. 31, 2005, the legal entity having the responsibility to process, collect, pay and/or report the STATE tax (in this example) of the US_SALES_TX tax regime uses the tax rate record defined by the FPO whose ID is 101, with a tax rate of 6% (corresponding to ID of 10 in Table 3.) Likewise, from 8 Aug. 2006 onward, the legal entity having the responsibility to process, collect, pay and/or report the STATE tax (in this example) of the US_SALES_TX tax regime appears to have been granted a comparatively more advantageous tax rate of 5.75% (tax rate ID 241) for the jurisdiction of California (Tax Jurisdiction Code CA) for the STANDARD tax status of the STATE tax of the US_SALES_TX tax regime. And for such purposes, the legal entity uses the tax content of the FPO whose content owner ID is 101. Table 3 may be used to determine, for example, the tax rate for the jurisdiction of California (Tax Jurisdiction Code CA) for the STANDARD tax status of the STATE tax of the US_SALES_TX tax regime for a taxable event that occurs, for example, during January 2006. As January 2006 does not fall within any of the date ranges defined by the “Effective To” and “Effective To” column of Table 3 for which the legal entity maintains its own CA sales tax content, the legal entity having the responsibility to process, collect, pay and/or report the sales taxes would use the tax rate record defined and maintained by the GCO for that purpose. This is because the tax owner ID for January 2006 is identified as −99, which is reserved, in this exemplary implementation, to the GCO. Therefore, the legal entity having the responsibility to process, collect, pay and/or report the taxes may subscribe to the GCO's tax content (or to a hierarchically higher legal entity's tax content), but may override the GCO's tax content with its own tax content, for a specified tax regime and for specified tax regime usage dates, for example. In this example, the legal entity would use its own tax content for taxes of the US_SALES_TX tax regime for the periods between Jul. 6, 2004 and Dec. 31, 2005 and from Aug. 8, 2006 onward, with the legal entity using the GCO's tax content for CA sales tax for all taxable events subject to such tax from Jan. 1, 2004 onward. In the same manner as tax rates may be selectively shared and overridden, so may tax rules, formulas, statuses and any other category of tax content, via similar mechanisms.

The content subscription options of “Own”, “GCO’ and “Own/GCO” are not the only content subscription options that may be implemented. Indeed, those of skill in this art may readily recognize that other content subscription options are possible. For example, FIG. 7 is a block diagram illustrating other content subscription options; namely, the “PCO” or Parent Content Owner and the “Own/PCO” content subscription options. As shown therein, legal entity 702 has subscribed to use the tax content of its parent legal entity; namely, legal entity 506. Legal entity 702, therefore, has selected the “PCO” content subscription option. Similarly, legal entity 704 has subscribed to the tax content of legal entity 508, but only for that tax content that it does not define and maintain itself. Hence, legal entity 704 has selected the “Own/PCO” tax content subscription option. According to some embodiments of the present invention, a legal entity may subscribe to the tax content of a parent legal entity only if the parent legal entity uses its own tax content (has selected the “Own” content subscription option).

It is to be noted that content subscription options for a same entity can be different for different tax regimes and for different time periods. However, the specified time periods should not overlap, as doing so may create a contention as to which set of tax content applies, in the absence of a priority ranking mechanism. Likewise, the time periods specified should be free of gaps, in which no content subscription option applies, unless it is an unlikely scenario where a particular legal entity is not subject to a given tax regime for an interval of time, having been subject to it before and after the interval. Moreover, in cases in which the “Own/PCO” content subscription option is selected, the date range specified for the tax regime usage should be within the time period in which the parent's “Own” content subscription option is active. Each legal entity, moreover, may be provided with a flag which, if set to a first state allows other legal entities to subscribe to its content and which, if set to a second state, disallows other legal entities to subscribe to its content. This flag may be set if the tax content owners do not believe that their tax content is applicable to any other legal entity or believes that their tax content should not, for some other reason, be shared within the hierarchy by any other legal entity.

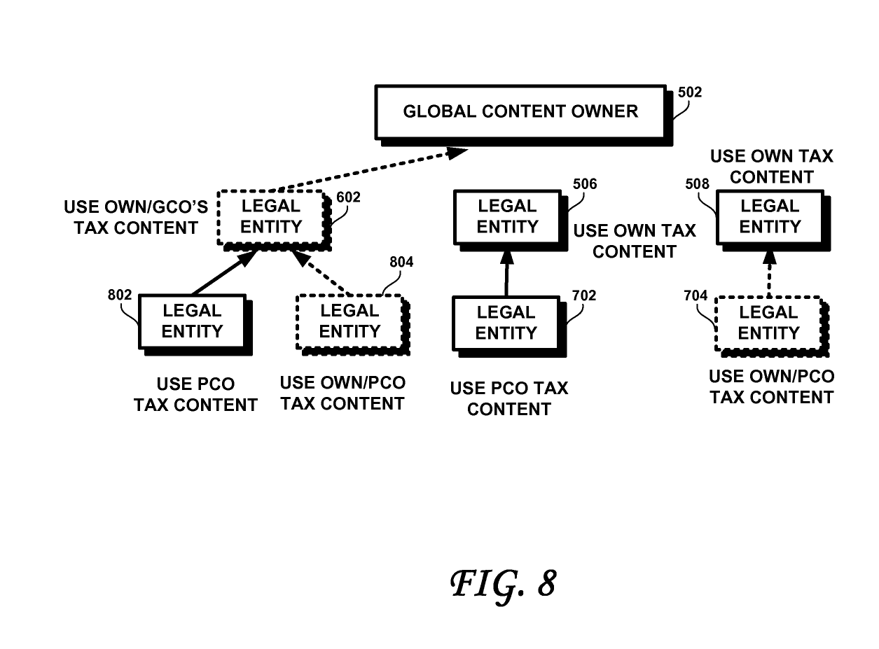

According to further embodiments of the present invention, a legal entity may specify “PCO” as a content subscription option even when the parent legal entity does not only use its own tax content. For example, FIG. 8 is a block diagram illustrating other content subscription options. For example, legal entity 602 has specified “Own/GCO” as their content subscription option for at least one tax regime and regime usage. Legal entity 802 may subscribe, according to an embodiment of the present invention, to the tax content of legal entity 602, but only for the time period(s) tax regime(s) and regime usage(s) for which the legal entity 602 uses its own tax content (as opposed to the GCO's tax content). For example, if legal entity 602 has selected to define and maintain its own tax content for tax regime R1 for the period of Jan. 1, 2008 to Jun. 1, 2008 and to use the GCO's tax content for that tax regime outside of that time interval, the legal entity 802 may subscribe to use the legal entity 602's tax content, but only for the period in which the legal entity 602 uses its own tax content; meaning for the time period between Jan. 1, 2008 and Jun. 1, 2008. To avoid cascading defaults of tax subscriptions across legal entities (i.e., reaching across more than one legal entity to obtain tax content), a legal entity may not, according to an embodiment of the present invention, be allowed to subscribe to the tax content of a parent legal entity outside of the regime usage interval for which the parent legal entity uses its own tax content.

Conversely and according to other embodiments of the present invention, an “Own/PCO” content subscription option may be specified in a case in which the parent legal entity itself has specified “Own/GCO”, but only for the time period and for the tax regime in which the parent legal entity uses its own tax content. For example and with reference to FIG. 8, legal entity 804 may specify “Own/PCO” as a content subscription option even though the parent legal entity has specified “Own/GCO”. However, legal entity 804, according to an embodiment of the present invention, would only be allowed to select such a content subscription option for the time period during which and for the tax regime for which the parent legal entity 602 uses its own tax content and not during the time period for the tax regime and regime usage during which the legal entity uses the tax content of the GCO 502. Other content subscription options may well occur to those of skill in this art, and all such content subscription options are deemed to fall within the scope of the present inventions.

Therefore, according to embodiments of the present inventions, the concept of content subscription extends to cover situations where a legal entity subscribes to the content of another legal entity, which in turn itself subscribes to the content of a third legal entity. This may be termed a two-level subscription hierarchy. This subscription hierarchy may not necessarily coincide with the legal entity reporting hierarchy nor correspond with the manner in which the transaction data itself is secured. In addition, and according to further embodiments of the present inventions, a legal entity may use the content subscription disclosed herein to use most but not all of the tax content of another legal entity. Moreover, the (subscribing) legal entity, through owning tax content of its own and tuning the content subscription through the content subscription options disclosed above, may exercise a fine-grained control over its tax collecting, paying and reporting responsibilities. For example, while a legal entity may share its tax content with a hierarchically-lower (in the sense that a legal entity which subscribes to another is “hierarchically lower”) entity (thereby lessening that legal entity's burden of defining, obtaining, entering and/or maintaining its own tax content), the hierarchically-lower legal entity may tailor some of its own tax content to reflect its own particular tax situation. For example, the hierarchically-lower legal entity may have been granted a local tax break or may shoulder an enhanced tax burden that is applicable to it but not to the hierarchically-higher legal entity to whose tax content it has subscribed—or, for that matter, to other legal entities that subscribe to the same (hierarchically-higher) legal entity for the same tax regime. Further, embodiments of the present invention provide a mechanism to easily share tax content and propagate changes to such tax content across the enterprise so that a change to tax content made by a central agency (for example, a Global Value Added Tax (VAT) department) will be reflected for all subscribing legal or business entities, by virtue of the subscription mechanism disclosed herein. Indeed, a change made to the tax content owned by a legal entity will be reflected in the processing of a taxable event of a legal entity that subscribes to that tax content at runtime, as the subscribing legal entity accesses the changed tax content and uses the changed tax content for its purposes (e.g., applies the accessed tax content to one or more taxable events to determine the taxes for such taxable events). Authorized users of each legal entity, according to embodiments of the present inventions, may be provided with the ability to change its subscription to tax content from one legal entity to another and may be provided with the ability to manage (i.e., change, delete, update) its own content and to manage the content of other legal entities for which such users have the authorization to act.

For a legal entity to switch subscription from one tax regime to another, or to subscribe to another regime in addition to ones already subscribed, the legal entity need only create a regime usage to start using the new regime. (For example, a legal entity may originally be subject to the US Sales Tax regime. Subsequently, they may be subject to US Federal Excise Tax regime. In such a case, this legal entity will need to create a regime usage for the US Federal Excise Tax regime, assuming for the purpose of this example that the US Federal Excise Tax regime has already been defined in the system.) Recall that legal entities are provided with the ability to define the effective periods for the usage of each tax regime. Therefore, to switch from one regime to another, a legal entity need only modify the Effective To (the end date) of the old tax regime, and create a new regime usage (including specifying at least an Effective From date; that is, a start date) for the new tax regime. To add the subscription to another regime, a legal entity need only create a regime usage (including specifying at least an Effective From date; that is, a start date) for the new tax regime.

Each legal entity, according to embodiments of the present invention, may be provided (though not necessarily) with a repository to store tax content and optionally tax records, which may include persistent copies of the results of tax calculations, and the like. Moreover, some or all of the legal entities (including the GCO) may also include and/or have access to a repository to store tax content data, which may include, for example, a set of data including rates, rules and regulations that are needed for tax calculations, reporting or settlement purposes.

However a legal entity accesses the tax content (i.e., (whether?) from another legal entity to whose tax content (or a selected portion thereof) the legal entity has subscribed or from the legal entity's own repository of tax content), upon occurrence of a taxable event for which the legal entity incurs a tax liability (whether payment liability, reporting liability, etc.), the accessed tax content may then be applied to the taxable event to determine the tax liability incurred as a result of the taxable event.

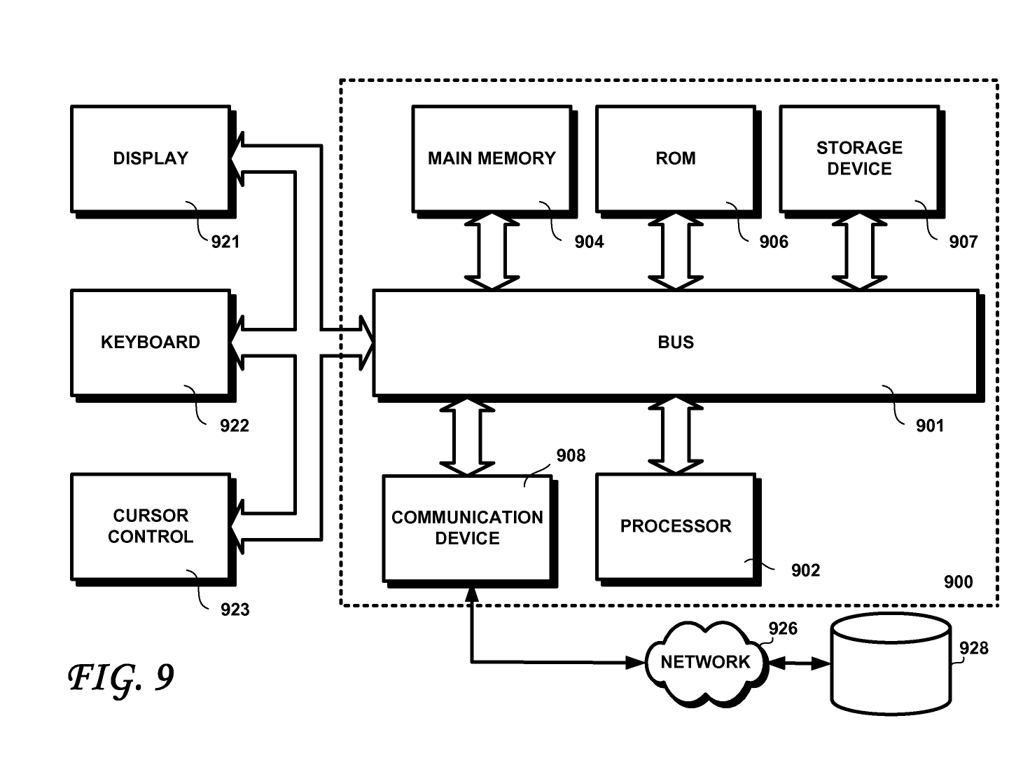

FIG. 9 illustrates a block diagram of a computer system 900 upon which embodiments of the present inventions may be implemented. Computer system 900 may include a bus 901 or other communication mechanism for communicating information, and one or more processors 902 coupled with bus 901 for processing information. Computer system 900 further comprises a random access memory (RAM) or other dynamic storage device 904 (referred to as main memory), coupled to bus 901 for storing information and instructions to be executed by processor(s) 902. Main memory 904 also may be used for storing temporary variables or other intermediate information during execution of instructions by processor 902. Computer system 900 also may include a read only memory (ROM) and/or other static storage device 906 coupled to bus 901 for storing static information and instructions for processor 902. A data storage device 907, such as a magnetic disk or optical disk, may be coupled to bus 901 for storing information and instructions. The computer system 900 may also be coupled via the bus 901 to a display device 921 for displaying information to a computer user. An alphanumeric input device 922, including alphanumeric and other keys, may be coupled to bus 901 for communicating information and command selections to processor(s) 902. Another type of user input device is cursor control 923, such as a mouse, a trackball, or cursor direction keys for communicating direction information and command selections to processor 902 and for controlling cursor movement on display 921. The computer system 900 may be coupled, via a communication device (e.g., modem, NIC) to a network 924 and to a repositories or databases 926 of tax content.

Embodiments of the present invention are related to the use of computer system and/or to a plurality of such computer systems to selectively share and override global tax configurations. According to one embodiment, the methods and systems described herein may be provided by one or more computer systems 900 in response to processor(s) 902 executing sequences of instructions contained in memory 904. Such instructions may be read into memory 904 from another computer-readable medium, such as data storage device 907. Execution of the sequences of instructions contained in memory 904 causes processor(s) 902 to perform the steps and have the functionality described herein. In alternative embodiments, hard-wired circuitry may be used in place of or in combination with software instructions to implement the present invention. Thus, the present invention is not limited to any specific combination of hardware circuitry and software. Indeed, it should be understood by those skilled in the art that any suitable computer system may implement the functionality described herein. The computer system may include one or a plurality of microprocessors working to perform the desired functions. In one embodiment, the instructions executed by the microprocessor or microprocessors are operable to cause the microprocessor(s) to perform the steps described herein. The instructions may be stored in any computer-readable medium. In one embodiment, they may be stored on a non-volatile semiconductor memory external to the microprocessor, or integrated with the microprocessor. In another embodiment, the instructions may be stored on a disk and read into a volatile semiconductor memory before execution by the microprocessor.

The data structures and code described in this detailed description are typically stored on a computer readable storage medium, which may be any device or medium that can store code and/or data for use by a computer system. This includes, but is not limited to, magnetic and optical storage devices, such as disk drives, magnetic tape, CDs (compact discs) and DVDs, and computer instruction signals embodied in a transmission medium (with or without a carrier wave upon which the signals are modulated). For example, the transmission medium may include a communications network, such as the Internet.

While the foregoing detailed description has described preferred embodiments of the present invention, it is to be understood that the above description is illustrative only and not limiting of the disclosed invention. Those of skill in this art will recognize other alternative embodiments and all such embodiments are deemed to fall within the scope of the present invention. Thus, the present invention should be limited only by the claims as set forth below.

What is claimed is:

1. A computer-implemented method of processing taxes in an enterprise that includes a plurality of legal entities, comprising the steps of:
maintaining tax content by a first legal entity of the plurality of legal entities;
subscribing, by a second legal entity of the plurality of legal entities, to at least a portion of the tax content maintained by the first legal entity;
upon occurrence of a taxable event for which the second legal entity incurs a tax liability, accessing at least a portion of the tax content to which the second legal entity has subscribed, and
applying the accessed tax content to the taxable event to determine the tax liability incurred as a result of the taxable event.

2. The computer-implemented method of claim 1, wherein the maintaining step is carried out with the first legal entity being a Global Content Owner (GCO) and wherein the tax content maintained by the GCO is visible to each of the plurality of legal entities of the enterprise.

3. The computer-implemented method of claim 1, wherein the maintaining step is carried out with the first legal entity further carrying out a step of subscribing to tax content maintained by a third legal entity of the plurality of legal entities of the enterprise.

4. The computer-implemented method of claim 1, wherein the tax content includes tax content of a plurality of tax regimes and wherein the subscribing step includes the second legal entity selecting to which of the plurality of tax regimes it is subscribing.

5. The computer-implemented method of claim 1, wherein the maintaining step is carried out with the tax content including tax rates, tax rules, formulae and tax statuses.

6. The computer-implemented method of claim 1, wherein the maintaining step includes a step of receiving the tax content from a tax service provider.

7. The computer-implemented method of claim 1, further including the second legal entity maintaining tax content and determining whether to apply the tax content maintained by the second legal entity or whether to access and apply the content maintained by the first legal entity to which the second legal entity has subscribed.

8. The computer-implemented method of claim 1, further including the second legal entity maintaining tax content and wherein the subscribing step includes specifying a content subscription option, the content subscription option indicating that the accessing and applying steps are to be carried out only when the tax content maintained by the first legal entity is not active or does not apply to the taxable event.

9. The computer-implemented method of claim 7, wherein, when the tax content maintained by the first legal entity applies to the taxable event, the method further includes the step of the second legal entity accessing the tax content maintained by the second legal entity and applying the accessed tax content to the taxable event to determine the liability incurred as a result of the taxable event.

10. The computer-implemented method of claim 1, wherein the tax content includes tax content of a plurality of tax regimes and wherein each of the tax regimes further includes a date from which the tax regime is effective.

11. The computer-implemented method of claim 10, each of the tax regimes further includes an end date after which the tax regime is no longer effective.

12. The computer-implemented method of claim 3, wherein the subscribing step effective only outside of a time period during which the subscription of the first legal entity to the tax content maintained by the third legal entity is active.

13. The computer-implemented method of claim 1, wherein the first legal entity maintains a flag configured to assume a first or a second state, the first and second states allowing and disallowing subscriptions, respectively, by other legal entities, to the tax content maintained by the first legal entity.

14. The computer-implemented method of claim 1, wherein the subscribing step is effective only for at least one of a tax regime and for a time period selected by the second legal entity.

15. A computer system for processing taxes in an enterprise that includes a plurality of legal entities, a first legal entity of the plurality of legal entities maintaining tax content, the computer system comprising:
at least one processor;
at least one data storage device coupled to the at least one processor;
a plurality of processes spawned by said at least one processor, the processes including processing logic for:
subscribing, by a second legal entity of the plurality of legal entities, to at least a portion of the tax content maintained by the first legal entity;
upon occurrence of a taxable event for which the second legal entity incurs a tax liability, accessing at least a portion of the tax content to which the second legal entity has subscribed, and
applying the accessed tax content to the taxable event to determine the tax liability incurred as a result of the taxable event.

16. A machine-readable medium having data stored thereon representing sequences of instructions which, when executed by a computing device, causes the computing device to process taxes in an enterprise that includes a plurality of legal entities, a first legal entity of the plurality of legal entities maintaining tax content, by performing the steps of:
subscribing, by a second legal entity of the plurality of legal entities, to at least a portion of the tax content maintained by the first legal entity;
upon occurrence of a taxable event for which the second legal entity incurs a tax liability, accessing the at least portion of the tax content to which the second legal entity has subscribed, and
applying the accessed tax content to the taxable event to determine the tax liability incurred as a result of the taxable event.

17. A computer-implemented method of processing taxes in an enterprise that includes a plurality of legal entities, comprising the steps of:
storing tax content locally to at least some of the plurality of legal entities;
subscribing, by a legal entity that stores tax content locally, to the tax content that is stored locally to a selected other one of the plurality of legal entities;
causing the subscribing legal entity to selectively access, upon occurrence of a taxable event, either the tax content to which it has subscribed or the tax content that is stored locally to the last one of the plurality of legal entities, and
causing the subscribing legal entity to apply the selectively accessed tax content to the taxable event to determine the tax liability incurred as a result of the taxable event.

18. The computer-implemented method of claim 17, wherein the subscribing step is effective for at least one of a selected tax regime and for a selected time period.

19. The computer-implemented method of claim 17, wherein the storing step is carried out with the locally stored tax content being effective for at least one of a selected tax regime and for a selected time period.

20. The computer-implemented method of claim 17, wherein the selective access step is carried out without the subscribing legal entity having any knowledge of the legal entity from which the tax content to which it has subscribed is fetched.
